(19) United States
(12) Patent Application Publication
(10) Pub. No.: US 2008/0029937 A1
(43) Pub. Date: Feb. 7, 2008

(54) DEVICE FOR PRODUCING STRAND-SHAPED PRODUCTS

(75) Inventor: Gerhard Gielenz, Wetzikon (CH)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(73) Assignee: BIOTRONIK VI PATENT AG, Baar (CH)

(21) Appl. No.: 11/776,921

(22) Filed: Jul. 12, 2007

(30) Foreign Application Priority Data
Aug. 2, 2006 (DE) 10 2006 035 960.7

(51) Int. Cl. B29C 47/54

(52) U.S. Cl. 264/555; 425/113

(57) ABSTRACT

A device to produce strand-shaped products from thermoplastic or elastomer materials comprising a paste extruder having a specially implemented internal volume defined by a cylindrical internal mandrel (2) and an external cylinder mantle (1). The polymer material is charged in the internal volume. The polymer raw material may be provided as a powder or granulate or as material cores produced in a separate precursor process using the same device. The polymer mass is melted by heating and discharged using an expulsion piston (3). A static mixing line (5) is provided in the outlet area, in which penetration of the melt flow occurs due to special shaping and uniform mixing of the molten material. A homogeneous material flow is achieved, which is supplied via a melt duct to a conventional longitudinal or transverse extrusion head (4).

### PRIORITY CLAIM

This patent application claims priority to German Patent Application No. 10 2006 035 960.7, filed Aug. 2, 2006, the disclosure of which is incorporated herein by reference in its entirety.

### FIELD OF THE INVENTION

The present invention relates to devices for producing strand-shaped products from polymer materials.

For purposes of the present disclosure, “strand-shaped products” are defined as extrudates of arbitrary length which are stretched, windable, or shaped in stretched length as hollow or solid profiles, having a cross-sectional geometry which may also have high-precision geometric dimensions. Typical products according to this definition include not only thin-walled insulated electrical wires, thin-walled single-lumen or multi-lumen microtubing, all-around cords, but also other conceivable miniaturized profiles, e.g., for sealing purposes in device construction, for mounting and packages as spacers, and much more.

In particular, the present invention relates to devices for producing high precision, thin-walled, polymer microtubing and microprofiles which are suitable for use in the medical field.

### BACKGROUND OF THE INVENTION

Conventional extruders are typically used for producing strand-shaped products from polymers. FIGS. 1 and 2 show two exemplary embodiments of known extruder constructions having attached conventional shaping tools (11). In a typical embodiment, a conventional extruder (10) comprises a heatable cylindrical receptacle, into which a polymer material is poured as a granulate, for example, via a hopper intake. The material is then melted by heating and supplied via a screw feed (a screw extruder) or a piston (paste, piston, or RAM extruder) via an extrusion head (11) flanged onto the extruder outlet for shaping the viscous polymer mass.

Special precautions are to be taken in the extrusion of strand-shaped products, in particular, thin-walled polymer tubing, which in turn result in relatively costly equipment and setup outlay. Even slight variations in the material transport during the shaping process, caused, for example, by pressure variations as a result of intake problems for a screw and/or intake geometry which is not designed optimally for the material, automatically result in deviations of the desired wall thickness because of the very small delivery amounts and thus to an undesired change of the geometrical and mechanical properties of the extrudate. In conventional extruders, because of the required injection volume, which is usually only very small, dwell times of the polymer in the extruder interior area which are too long also result, which may result in prior thermal damage of the polymer material.

The quality requirements are very high in the field of medical technology, in particular, so that additional precautions must be taken for typical extruders to maintain the narrow specifications. A correspondingly complex device for producing thin-walled polymer tubing for medical applications is described in U.S. Pat. No. 6,814,561, the disclosure of which is incorporated herein by reference in its entirety. In this extruder, the molten material (PTFE, ePTFE) is discharged by a piston, which is guided via a specially implemented mechanism. Various guide elements are provided, which ensure that a central guide rod always remains in precise axial orientation during the feed.

### SUMMARY OF THE DISCLOSURE

One feature of the present invention is to provide a device for producing arbitrary strand-shaped products which ensures high precision of the extrudate with simultaneous simple handling of the process.

One exemplary embodiment of the present invention provides an extruder for extruding strand-shaped products made of thermoplastic or elastomer materials, having an internal volume to be charged with polymer raw material, heating elements for melting the polymer raw material in the internal volume, and means for discharging the molten material thus obtained into an outlet area, which is connected via an outlet channel to an extrusion head. The internal volume of the extruder is formed as an intermediate space between an external cylinder and a cylindrical internal mandrel. The external cylinder and internal cylinder are situated coaxially to one another and a tubular expulsion piston, whose dimensions are tailored to the internal volume to form a seal, is provided as the means for discharging the molten material.

According to one feature of the present invention, to produce strand-shaped products from thermoplastic or elastomer materials, a paste extruder having a specially implemented internal volume is provided, which is defined by a cylindrical internal mandrel and an external cylinder mantle having a circular cross-section. The polymer material (e.g., PE, PA, TPU or other suitable thermoplastic polymers and elastomers) is charged in the internal volume. The polymer raw material may be provided as a powder or granulate, for example. However, other cross-sectional shapes are also conceivable for the design of the internal volume, such as an ellipse or a regular or irregular N-sided polygon having N greater than or equal to 3.

The device may also be used for producing tubular material cores (or cores having different shapes in accordance with the design) from this powder or granulate. Such cores ensure more rapid and efficient handling of the polymer material during the extrusion of the strand-shaped products.

In an expanded exemplary embodiment of the extruder, a vacuum flange is provided for the external cylinder, via which the air in the charging volume may be pumped out using oil-free pumps after the charging with polymer raw material.

The polymer mass is melted by heating and the molten material is then discharged using an expulsion piston via a hydraulic, electrical, or pneumatic drive unit. For this purpose, the piston displacement is detected via corresponding displacement sensors. A mixing line—which is preferably also needed—is provided in the discharge area, in which penetration of the melt flow in the meaning of a static mixing part occurs by special shaping and thus uniform mixing of the molten material is achieved.

Means for detecting temperature and pressure of the molten mass are provided in the adjoining transition area from the extruder to the shaping part (extrusion head). The pressure signal obtained is used via control units in connection with the displacement signal for immediate regulation of the piston propulsion in the meaning of a pressure-displacement regulation. Therefore, an oscillation-free material flow is achievable, which may be supplied via a melt duct and heated flange connections to a conventional longitudinal or transverse extrusion head, preferably having manual fine centering.

Because the material quantities for microtubing are very small, the free volumes of the melt duct and in the extrusion head are minimized as much as possible (microextrusion head). Possible flow anomalies caused by rheological effects, such as compression or “slip-stick” effects, may be reduced in such a way that the melt may exit from the joint flow path of the tubing mold practically without pulsation and, therefore, only the strand expansion as a function of the mass pressure and the withdrawal velocity have to be taken into consideration for the resulting geometry of the extrudate.

A conventional cooling, calibration, and withdrawal unit, including a cutting device, which is adapted in dimensions to the small extrudate diameter, is connected downstream.

The present invention is explained in greater detail in the following on the basis of an exemplary embodiment with reference to the figures and the reference numerals specified therein.

### BRIEF DESCRIPTION OF THE DRAWINGS

FIG. 1 shows a conventional prior art single-screw extruder having a conventional extrusion head as the molding tool;

FIG. 2 shows a conventional prior art piston extruder having a conventional extrusion head as the molding tool;

FIG. 3 shows an overview construction of an exemplary embodiment of the extruder according to the present disclosure;

FIG. 4 shows a perspective view of the cylindrical internal mandrel of the extruder;

FIG. 5 shows a top view of the internal mandrel having dimension specifications;

FIG. 6 shows a perspective view of tubular expulsion pistons;

FIG. 7 shows a schematic view of the expulsion piston having dimension specifications;

FIG. 8 shows a perspective view of the external cylinder;

FIG. 9 shows the external cylinder in a half-shell illustration;

FIG. 10 shows a top view of the external cylinder having dimension specifications;

FIG. 11 shows a perspective view of a disassembled extruder in coaxial configuration of the individual elements; and

FIG. 12 shows a modular construction for parallel operation.

### DETAILED DESCRIPTION OF THE EMBODIMENTS

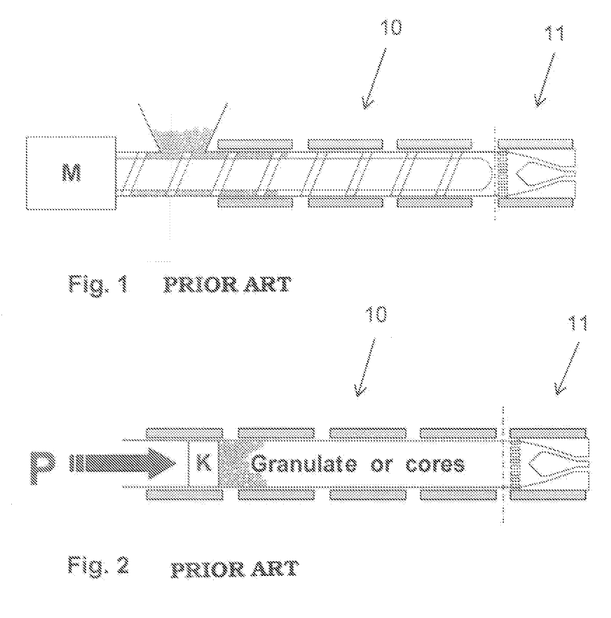

For comparison, FIGS. 1 and 2 show known extruders (10) of conventional construction having screw and piston mechanisms, respectively, flanged-on molding parts (11), and correspondingly designed heating elements for a multistage zone heating of the process volume.

FIG. 3 schematically shows an exemplary embodiment of the extruder according to the present invention having open external cylinder (1), cylindrical internal mandrel (2), tubular expulsion piston (3), and transverse microextrusion head (4). These components are tailored to one another in their dimensions and charge volumes. The materials of the surfaces of external cylinder (1), internal mandrel (2), and expulsion piston (3) are preferably selected for optimal mechanical stability in regard to sliding behavior and abrasion resistance. For this purpose, the surfaces of the extruder elements may have a special wear-reducing and/or adhesion-reducing coating, e.g., made of titanium nitrite.

Depending on the desired cross-sectional profile of the extrudate, the extruder may preferably be used with arbitrary conventional longitudinal or transverse extrusion heads, preferably having very short and volume-reduced flow paths (microextrusion head), and having correspondingly designed molding tools.

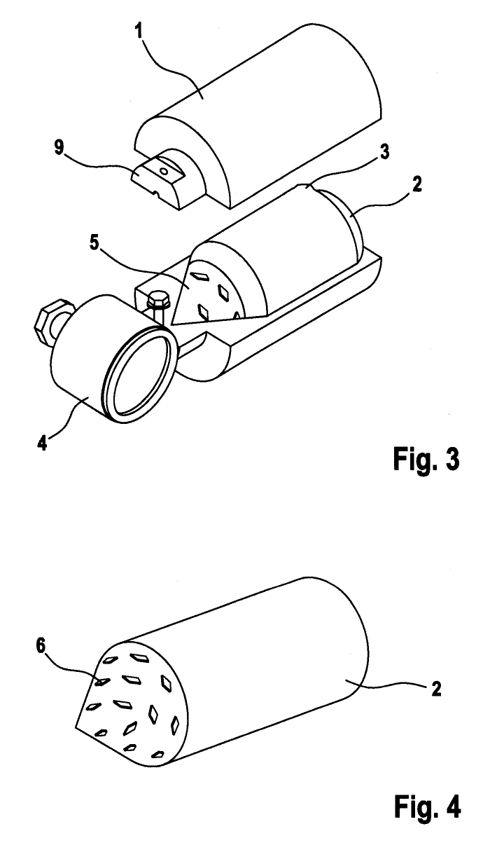

The internal mandrel (2) is illustrated in FIG. 4. Multiple heating elements, e.g., high-performance heating cartridges, are attached in a formfitting way in the internal mandrel (not shown). The heating elements of the internal mandrel may preferably be activated individually. Thermal sensors are also attached in the internal area of the internal mandrel, which detect the current temperature distribution. An optimal homogeneous heat distribution may thus be set and maintained using corresponding regulation of the distributed heating elements.

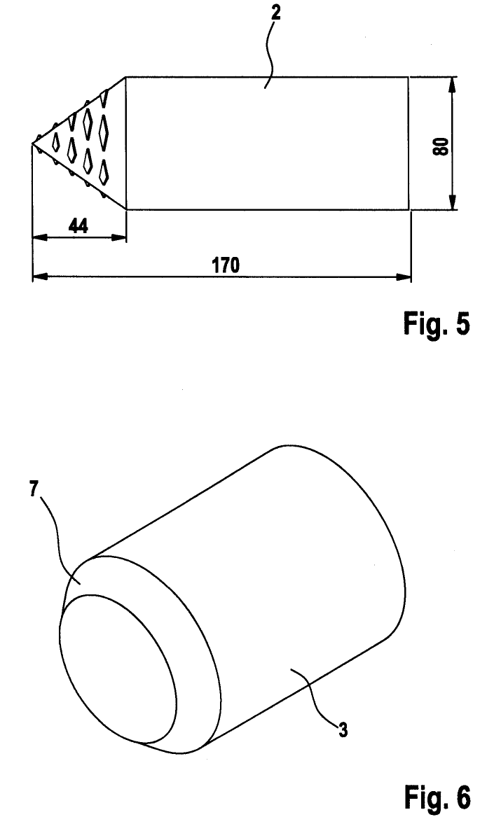

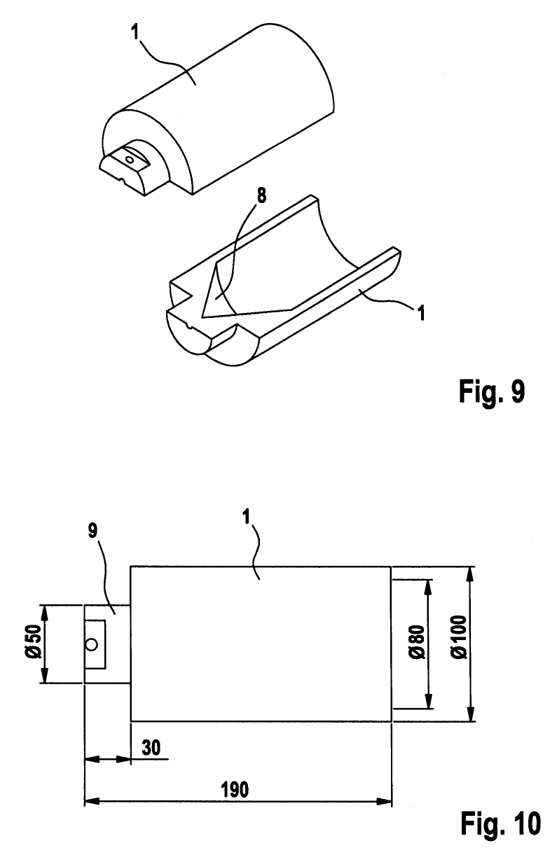

In the preferred exemplary embodiment, the internal mandrel has a conical taper (5) in the outlet area, the associated external cylinder (1) has a correspondingly tapered shape (8) as a counterpart in this area as shown in FIG. 9. Additional surface structures (6) may be introduced into this conical area, which ensure uniform mixing of the melt as it flows out. The surface structures (6) are preferably implemented as rhomboid. FIG. 5 shows the internal mandrel in a top view having typical dimension specifications in millimeters as a possible exemplary embodiment.

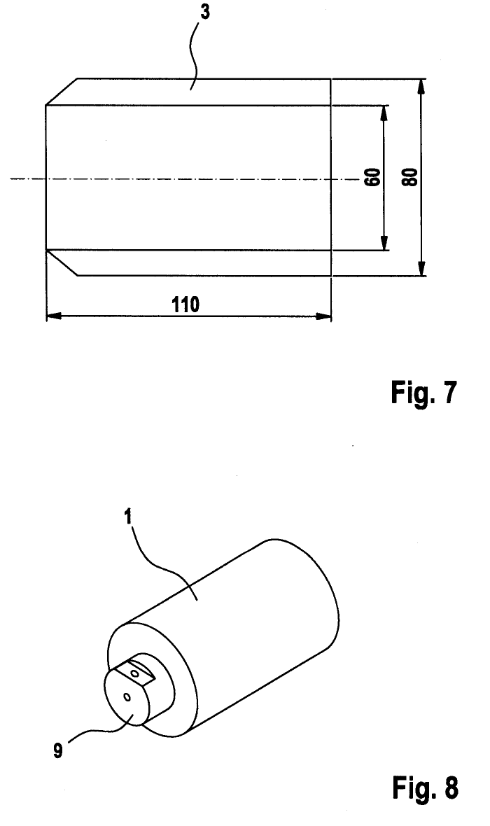

FIG. 6 shows the tubular expulsion piston (3) in perspective. The internal diameter of the expulsion piston (3) is tailored to the cross-section of the internal mandrel, so that, in the heated state, the lowest possible resistance in sliding is ensured while simultaneously having the smallest possible intermediate space. The conically tapering front (7) of the expulsion piston (3) is tailored to the shaping of the internal mandrel (2) and the external cylinder (1) in the outlet area and thus ensures a minimal residual volume after the discharge procedure. FIG. 7 shows the preferred possible dimensioning of the tubular expulsion piston (3) in accordance with the dimensioning of the internal mantle (2) from FIG. 5.

FIG. 8 shows a perspective view of the external cylinder (1). FIG. 9 shows a half-shell illustration to indicate the shaping of the internal area. Here as well, the internal outlet area (8) is designed as conically tapering and tailored to the shaping of the internal mandrel (2). The exit flange (9) is the connection point for the mass pressure and mass temperature sensors, as well as for the microextrusion head (4) (compare FIG. 3). For better handling during startup of the device, a (heated) bypass may also be interposed between external cylinder and extrusion head (not shown). The dimension specifications for the external cylinder (1) of this exemplary embodiment preferably result from FIG. 10.

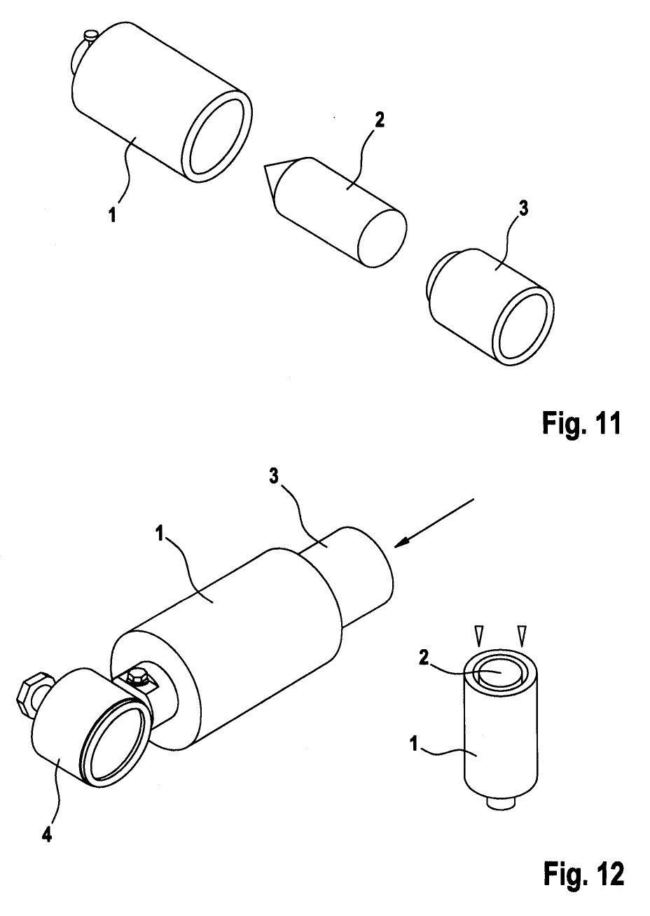

Various advantages result in operation due to the modular construction of the extruder from individual components inserted one into another, as shown in FIG. 11. Thus, the extruder may be disassembled very easily, for example, for cleaning, in that internal mandrel (2) and expulsion piston (3) may be pulled out of the external cylinder (1). External cylinder (1) and internal mandrel (2) may also be removed from the extrusion head (4) for a parallel operation, as shown in FIG. 12, and the intermediate space may be recharged with granulate, a second pair of external cylinder/internal mandrel (12) being placed on the extrusion head (4) in parallel and extrudate being produced using expulsion piston (3).

In an alternative exemplary mode of operation, the extruder according to the present disclosure may be used in a first process step without extrusion head and having closed exit flange by heating and compressing granulate for producing tubular cores which are, for example, additionally pigmented material. These material cores molded in this way, which are producible for a reserve, may then be processed further using the same device and downstream extrusion head to form strand-shaped products (principle “hot-melt glue gun”).

The actual process for producing the strand-shaped products may be made significantly more rapid and efficient by the very rapid and simple-to-handle charging of the extruder with the polymer material thus achievable.

Using the dimensions of the exemplary embodiment specified in FIGS. 5, 7, and 10, the preferred polymer charge volume is approximately 225 cm³. While maintaining a compact construction length, the charging volume may be tailored to the application by enlarging the cylinder and piston diameters. For example, when extruding tubing having a weight of less than or equal to 1 g/m and a material density of 1 g/cm³, more than 200 meters of microtubing are producible using one charge. In the event of significantly smaller weights per meter of the microtubing to be manufactured, the possible manufactured length per charge is correspondingly even greater using the given usable expulsion volume. Due to the small residual volumes (e.g., also optimized by the beveling of the expulsion piston toward the exit area) only a few percent (a few cm³) of the material remains unused in the extruder.

In relation to the conventional devices illustrated in FIGS. 1 and 2, the extruder according to the present disclosure is distinguished by a compact, extremely mechanically stable construction, which manages without material-specific screw delivery or complex guide elements (e.g., “guide rods”). The extruder may be tailored without special construction outlay to extremely small extrudate dimensions and minimal molten material quantities solely by corresponding dimensioning of the individual components. In this way, the dwell times in the molten state are kept very short and material damage of the molten material may thus be reduced and/or precluded.

In addition, the thermal strain of the polymer material in the extruder may be minimized further by heating elements and thermal sensors distributed spatially in the extruder, which may be gradually activated individually over the complete method length and adapted to the optimum temperature profile of the particular molten material. This is very advantageous for the production of thin-walled extrudates, in particular, using thermally sensitive polymers having only very narrow processing temperature windows.

By optimizing the polymer flow behavior as a function of pressure, temperature, and process volume using the measures described above, nearly pulsation-free discharge of the molten mass results, in particular, in connection with the detection of the pressure of the molten mass as a control variable for the propulsion regulation of the expulsion piston. Therefore, oscillations in the extrudate dimensions are essentially only caused by the molecular parameters of the material used. The predefined tolerance values of the produced microtubing may thus be kept in narrow limits. Discards are thus largely avoided and the testing outlay for quality control may be significantly reduced.

Because the various control procedures (regulation of the discharge procedure, etc.) may be largely automated, very short equipping and startup times result even if different materials are used. Because of the simple operation of the extrusion process and the comparatively extremely compact dimensions of the extruder, less personnel and time outlay and only a small amount of space are to be used in relation to a conventional extrusion line. The extruder may be used in practically any arbitrary spatial position. Overall, the personnel, maintenance, and investment costs are significantly lower if the extruder according to the present invention disclosure is used.

All patents, patent applications and publications are incorporated by reference herein in their entirety.

Claimed is:

1. A device for extruding strand-shaped products made of thermoplastic or elastomer materials, comprising:
a) an internal volume to be charged with polymer raw material;
b) heating elements for melting the polymer raw material in the internal volume; and
c) means for discharging the molten material thus obtained into an outlet area, which is connected via an outlet channel to an extrusion head;
wherein the internal volume is formed as an intermediate space between an external cylinder and a cylindrical internal mandrel, the external cylinder and internal cylinder being situated coaxially to one another and a tubular expulsion piston, whose dimensions are tailored to the internal volume to form a seal, is provided as the means for discharging the molten material.

2. The device of claim 1, wherein the internal volume tapers conically toward the outlet channel in the outlet area, the interior of the external cylinder has a conical shape and the cylindrical internal mandrel is correspondingly implemented as conical.

3. The device of claim 2, wherein the surface structures are provided in the conically tapering area of the internal volume on the inner wall of the external cylinder or the conically tapering area of the internal mandrel, which cause mixing of the molten material during the discharge procedure.

4. The device of claim 1, wherein the tubular expulsion piston has a conical taper toward the outlet area.

5. The device of claim 1, wherein at least one sensor for measuring the pressure of the molten material is provided, in particular, at the exit flange of the extruder.

6. The device of claim 5, further comprising means for detecting the position of the expulsion piston and means for regulating the piston propulsion as a function of the measured pressure in the molten material.

7. The device of claim 6, further comprising means for pumping out existing air in the internal volume after charging with polymer raw material.

8. The device of claim 7, wherein the heating elements are inserted spatially distributed into the internal mandrel,

9. The device of claim 5, wherein the heating elements may be regulated individually or in multiple groups using correspondingly attached thermal sensors and downstream regulating units.

10. A use of the device according to claim 1 for producing material “cores” pre-molded according to the internal volume for more rapid and simpler handling of the polymer raw material during charging of the extruder according to the present invention for the actual manufacturing step of “extrusion of the strand-shaped product”.

11. The device of claim 7, wherein said heating elements are heating cartridges.

12. The device of claim 7, wherein the heating elements are situated neighboring one another on the external lateral surface of the external cylinder for melting the polymer raw material.

13. The device of claim 12, wherein the heating elements are heating strips.
